(19) United States
(12) Patent Application Publication
(10) Pub. No.: US 2009/0007211 A1
(43) Pub. Date: Jan. 1, 2009

(54) Cable set-top box with voice over internet protocol

(75) Inventors: Mohit Mathur, Olathe, KS (US); Michael P. Morrissey, Overland Park, KS (US)

Correspondence Address: PATTON BOGGS, LLP, 2001 ROSS AVENUE, SUITE 3000, DALLAS, TX, 75201, US

(73) Assignee: EMBARQ HOLDINGS COMPANY, LLC

(21) Appl. No.: 11/824,261

(22) Filed: Jun. 29, 2007

(51) Int. Cl. H04N 7/173

(52) U.S. Cl. 725/126

(57) ABSTRACT

A cable set-top box with voice over internet protocol includes a housing; a coaxial cable input for accepting a coaxial cable containing a video content signal and a data content signal from a provider, the data content signal for providing the voice over internet protocol to a telecommunication's device; a demultiplexer for splitting the video content signal and the data content signal; a video output for accepting a video line for transmitting the video content signal to a video device; and a data output for accepting an audio line for transmitting the data content signal to a telecommunications device.

### FIELD OF THE INVENTION

The present invention relates to a cable set-top box including a tuner for receiving video and data over cable, more particularly, the present invention relates to a cable set-top box for providing a video and audio output and a voice over internet protocol output for a session initiation phone.

### BACKGROUND OF THE INVENTION

Today, video set-top boxes support coaxial feeds from cable companies and satellite feeds from satellite companies of video program content to user's televisions. When a user wishes to utilize data transmissions, such as for Internet access, separate devices are used to provide such access. In addition, if users further wish to utilize IP-enabled voice phone through the use of an analog phone, in voice over internet protocol (“VOIP”) services; these too are provided by a separate device. Typically, a broadband cable or DSL modem is additionally required for the internet connection and an integrated access device (“IAD”) is required for the VOIP service.

Originally, cable television was a one-way transmission system for the delivery of analog video signals to subscribers through a network of coaxial cables. The initial cable TV network comprised a network tree architecture in which analog video signals were transmitted from a head end located at and operated by the cable TV operator's central location to individual subscribers via main trunks, sub-trunks, and feeders of the network tree. Periodically along the line, analog amplifiers were used to boost the analog video signal. Nevertheless, the benefits of such amplifications were offset by the introduction of noise and distortion directly attributed to the analog amplifiers.

Typically, the subscriber's television required a cable set-top box, also known as a cable converter box, to receive the analog signals for displaying on the television. The cable set-top box generally included several tuners for selecting a single video channel from the ultra high frequency (“UHF”) band of 470-860 MHz., the very high frequency (“VHF”) band of 170-470 MHz., and VHF low band of 54-170 MHz. respectively, for television viewing.

Digitizing the video signal at the head end enables the cable operator to improve transmission quality by, for example, improving the signal to noise ratio and increasing transmission capacity by hardware and/or software compression of the digitized video signal. For example, the Moving Picture Experts Group (“MPEG”) standard provides an algorithmic means of compressing the digitized video signal, such that as many as 10 to 12 video channels may be transmitted in a single 6.0 MHz. bandwidth. Digitizing the downstream video signal also allows for data communication on the same 6.0 MHz. channel.

In the 1980s, the cable TV companies installed optical fiber cables that offered improvements to the cable network in both quality, by, among other things, enhancing the signal to noise ratio, and in capacity, by providing greater transmission bandwidth for video signals. The initial deployment of these optical fiber cables was limited to an optical fiber-based backbone typically corresponding to the main trunks of the existing coaxial network tree because of the expense in laying the optical cable. This optical fiber-based backbone was then connected to coaxial cables of the subtrunks and feeders of the network tree to form a hybrid fiber coaxial (“HFC”) network.

Both coaxial and HFC cable systems have been used for the two-way transmission of digital data according to the cable companies standard known as Digital Over Cable Interface Specification Standard (“DOCSIS”). The DOCSIS is outlined in part in “Data Over Cable Service Specifications Radio Frequency Interface SP-RF1-104-980724” and is supported by Cable Labs, a consortium of cable TV operators. The digital data may be internet data or digital audio and video data from one or more external sources to the cable TV system network. The DOCSIS assigns downstream transmissions to a bandwidth of 88-160 MHz., while downstream DOCSIS transmissions may be assigned to a bandwidth of 5-42 MHz.

The interface of the DOCSIS corresponds to the data link and physical layers of the well known Open Systems Interconnection Basic Reference Model (“OSI model”), a layered architecture that standardizes levels of service and types of interaction for digital processors exchanging information through a communications network. The DOCSIS layers are defined as: an Internet Protocol (“IP”) network layer; a data link layer comprising a logical link control sublayer conforming to Ethernet standards; a linked security sublayer for basic privacy; authorization and authentication; and a Media Access Control (“MAC”) sublayer for operation supporting variable length protocol data; and a physical layer comprising a downstream convergence layer conforming to MPEG and physical media dependent sublayer.

The digital data is formatted into packets under the MAC protocol and access to transmission follows time division multiple access (“TDMA”). In the upstream direction, TDMA separates multiple communication transmissions over the finite frequency bandwidth of the cable TV network TDMA assigns a frequency bandwidth for each communication and assigns a specific time slot for transmission. A formatted packet of information is transmitted during an assigned time slot.

Because these new cable lines carry both data and video, users wishing to feed a video signal through their televisions must presently use a cable set-top box (“STB”) and if they wish to use a analog phone for VOIP services, they also need a separate broadband cable modem for the internet connection in addition to an IAD required for the VOIP service.

### SUMMARY

The cable STB with VOIP simplifies the service delivery to the consumer. The cable STB with VOIP operates using IP and will have an IP address assigned to it from the cable company. The cable STB with VOIP has a VOIP phone jack, such as an analog phone RJ-11 jack (port) and will support any cord or cordless home phone unit. The video service will be delivered to the cable STB with VOIP over an internet protocol multicast stream from the service provider. The internet access and phone service will be delivered over internet protocol unicast. The VOIP phone service may have two options. It may be provided by the cable provider if they have a VOIP switch, or it may be provided by a third party VOIP operator, such as a telecommunications company.

The cable STB with VOIP simplifies the delivery and bundling of voice and video services to the consumer. It does not force the consumer to get a broadband connection to support the VOIP services. It also reduces the cost of the consumer premises equipment (“CPE”) for the service provider.

The user may have the option of using the cable company's VOIP service or any other VOIP provider. The VOIP provider option can be configured in the cable set-top integrated access device using the Ethernet port. The cable STB with VOIP would allow the cable company to unbundle their internet service from the VOIP service. This may reduce the cost of phone service to the customer and allow the flexibility of selecting the VOIP vendor.

The integrated cable set-top box of VOIP provides aggregation for services on a single CPE customer premise device. DOCSIS defines communications requirements for support of high speed data service over cable TV (CATV), over hybrid fiber coaxial (HFC) infrastructure. In one embodiment, the cable set-top box with voice over internet protocol includes a housing; a coaxial cable input for accepting a coaxial cable containing a video content signal and a data content signal from a provider, the data content signal for providing the voice over internet protocol to a telecommunication's device; a demultiplexer for splitting the video content signal and the data content signal; a video output for accepting a video line for transmitting the video content signal to a video device; and a data output for accepting an audio line for transmitting the data content signal to a telecommunications device.

### BRIEF DESCRIPTION OF THE DRAWINGS

FIG. 1 illustrates a block diagram of an exemplary cable STB with VOIP according to an embodiment of the present invention.

### DETAILED DESCRIPTION OF THE DRAWINGS

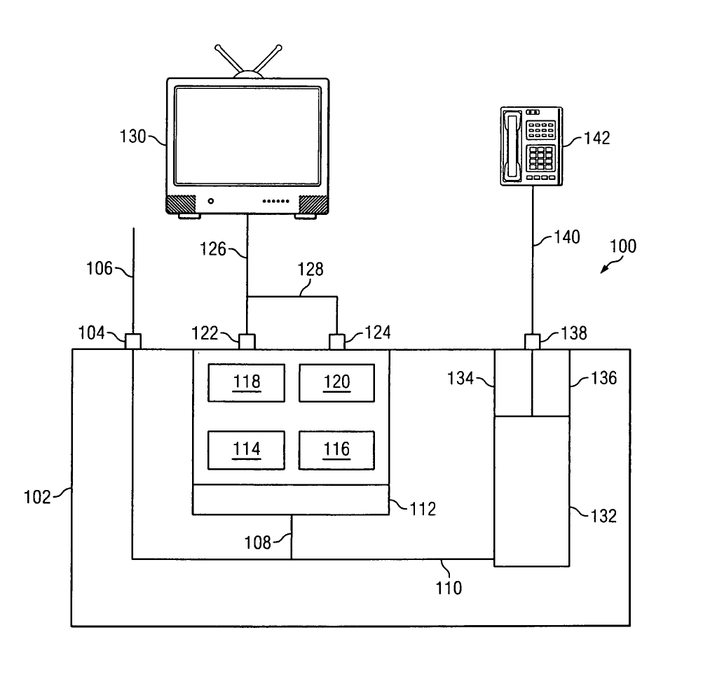

In the drawing, like or similar elements are designated with identical reference numerals throughout the FIGURE thereof, and various depicted elements may not be drawn necessarily to scale. For example, for viewing convenience, the cable STB with VOIP is enlarged in FIG. 1 relative to the electronic peripheral devices also shown.

FIG. 1 illustrates an embodiment 100 of a cable STB with VOIP, including a housing 102 for housing the circuitry and electronics contained therein. The cable STB with VOIP 100 includes a coaxial cable jack 104 for accepting a coaxial cable 106 carrying electronic signals, such as voice and data from a cable TV operator. Coaxial cable 106 enters the housing 102 and is split into a tuner feed 108 and a telephone feed 110.

Cable STB with VOIP 100 may also include a tuner 112 in communication with tuner feed 108. The tuner 112 operates in accordance with that commonly known to those skilled in the art. In addition, it may also include video decoder 114, digital signal processor (“DSP”) 116, video digital to analog converter (“video DAC”) 118, and audio coder-decoder (“audio codec”) 120. Output of video DAC 118 may be video jack 122. An output of audio codec 120 may be audio jack 124. Typically, left and right (“L/R”) audio line 128 may be connected to audio jack 124 and separately connected to television 130 or incorporated into the television feed 126, exiting the video jack 122 prior to being connected to the television 130.

Cable STB with VOIP 100 may further include Dynamic Host Configuration Protocol (DHCP) unit 132 in connection with phone feed 110 and DSP 134 and analog to digital converter codec (“ADC codec”) 136. DSP 134 and ADC codec 136 may be in communication with phone jack 138 that is in communication with telephone line 140, connecting the analog telephone 142 to the cable STB with VOIP 100.

The cable STB with VOIP 100 will support standard DOCSIS 1.0/1.1/2.0/3.0 cable modem specifications to process data traffic before it is passed on to the Ethernet driver associated with DHCP. The IP layer may support the following standard: TCP, UDP, SNMP, ICMP, DHCP, ARP, and RARP to work in conjunction with the Ethernet layer. Other protocols like HTTP, TFTP, and FTP may be required for standard data applications such as internet browsing, file transfer, etc.

The cable STB with VOIP 100 may also include standard circuitry for interconnecting the various electronic elements and units described herein. The VOIP signaling may be compatible with standard H.323 and/or SIP. The voice traffic is differentiated from the data traffic by the information in OSI model layers 3 and 4 header of the data packets transmitted through the coaxial cable 106. The IP address in layer 3, along with the SIP destination helps in routing of the voice traffic to the appropriate soft/call server. The circuitry of the cable STB with VOIP 100 provides connection to a regular analog phone using a RJ-11 port designed for VOIP. It may have an ADC to convert voice signals into digital bits. It also may have the DSP function within its circuitry with DTMS detection and generation function. Standard codec circuitry may also be included in the circuitry of the cable STB with VOIP 100 to provide support for G.711, G.726, and G.729 voice service.

The coaxial cable 106 may typically be a coaxial cable, rigid or flexible. Typically, the coaxial cable 106 may include an outer plastic sheath, a copper screen, an inner dielectric insulator and a copper core. The coaxial cable 106 may have a characteristic impedance of 50, 52, 75, or 93 Ohms. The RF industry may typically use standard names for coaxial cables such as RG-6 being the most commonly used coaxial cable. In addition, coaxial cable 106 may further include connectors on its ends for connecting the coaxial feed from the cable company to the cable STB with VOIP 100.

In an embodiment of the present invention, the head end of the cable system may include a Cable Modem Terminating System (“CMTS”) that may receive digitized data, for example, internet data. As is well known in the art, the digitized data may be formatted according to a MAC protocol appropriate to the CMTS at the head end of the cable TV operator. The formatted, digitized data may then be transmitted downstream from the head end to the cable STB with VOIP 100 corresponding to a single downstream channel including a plurality of downstream channels according to the DOCSIS. As is also well known in the art, the downstream data may be formatted according to MPEG frame format or according to the MAC protocol appropriate to the CMTS at the head end and according to the DOCSIS.

Both the MPEG data packets and the digitized DOCSIS data packets may then be modulated and multiplexed according to a TDMA protocol at the head end of the cable system to form an MPEG transport stream for transmission along or through a coaxial cable input 106. The MPEG transport stream may then be demultiplexed into data streams containing either MPEG data or digitized DOCSIS data by the cable STB with VOIP 100. The tuner 112 tunes or selects a single downstream channel from the plurality of downstream channels transmitted by means well known in the art. In an embodiment of the present cable STB with VOIP 100, the tuner 112 may select that single downstream channel in which the DOCSIS digitized data is contained.

DOCSIS uses Quadrature Amplitude Modulation (QAM) techniques for upstream and downstream encoding of data across a 6-8 MHz. radio frequency band. The video signal adheres to National Television Standards Committee (NTSC) in North America or phase alternating line (PAL) international analog specifications, along with Advanced Television Systems Committee (ATSC) in North America and digital video broadcasting (DVB) international digital specifications standards.

The MPEG data is demultiplexed from the same MPEG transport stream that carries the DOCSIS data by a demultiplexer and transmitted to video decoder 114 in communication with the DSP 116. This signal is then sent to the audio codec 120 and video DAC 118 for transmitting through video jack 122 and audio jack 124 for transmission through television line 126 to television 130.

In one embodiment, the head end of the cable company up-puts digitized data from multiple external sources at a rate of about 38 Mbps according to a DOCSIS standard. This rate of data transmission may be combined with selection of a short interleaver to minimize latencies. The unicast data may be formatted according to a MAC protocol appropriate to the head end of the cable company.

As discussed above, a QAM demodulator may demodulate the digitized signal having a transmission rate of about 38 Mbps by using variations in signal amplitude and phase as is well known in the art. The demodulated digitized data may be filtered to a particular downstream transmission channel according to DOCSIS unicast data. This then provides digitized DOCSIS data destined to a particular user to be unicast over a particular downstream channel, which is selected by a filter acting upon subscriber identification data, such as for example MAP. The filtered DOCSIS data for each downstream transmission channel may also include synchronization data in another control data well known to those in the art for fulfilling the DOCSIS standard.

In one embodiment, the filtered DOCSIS unicast data from each filter may then be transmitted to a corresponding multiplexer. The time division multiplexes the MPEG compressed video data with the filtered DOCSIS data to a corresponding downstream channel for transmission over the coaxial cable input 106. Other means of this function may be achieved through a statistical multiplexer that allocates shares of the available downstream transmission bandwidth dynamically.

The DHCP 132 of the present cable STB with VOIP 100 may contain a set of rules used by communications devices such as computers, routers, and network adapters to allow the device to request and obtain an IP address from a server. The DHCP 132 is a protocol used by network computers to obtain IP addresses and other parameters such as the default gateway subnet mask and IP addresses of DNS servers from a DHCP server. In one embodiment, when the cable STB with VOIP 100 is turned on, the DHCP 132 sends out a query requesting a response from a DHCP server on the locally attached network.

As described above, DOCSIS data over cable service interface specifications is an international standard developed that defines communications and operations to support interface requirements for transporting data over a cable system. Typically, it is employed by many cable television operators to provide internet access over the existing HFC infrastructure. The present cable STB with VOIP 100 operates and includes all previous and current versions of DOCSIS. Further, DOCSIS provides a good variety of options available at the OSI layers one and two, and the physical and MAC layers. For example, in the physical layer, DOCSIS 1.0/1.1 specifies channel width between 200 kHz. and 3.2 MHz. DOCSIS 2.0 may specify approximately 6.4 MHz. These are typical channel widths for DOCSIS. Beginning modulation in DOCSIS 1.0, 1.1 and 2.0 specify that the 64 level or 256 level QAM be used for modulation of downstream data and QPSK, or at 16 level, QAM, be used for upstream modulation. Further regarding the MAC layer, DOCSIS employs a mixture of deterministic access methods, specifically TDMA and Synchronous Code Division Multiple Access (“SCDMA”). In the current cable STB with VOIP 100, these DOCSIS cable modem specifications process the data traffic generally before it is passed on to the Ethernet driver that is a part of DHCP 132, ADC codec 136, and DSP 134.

As discussed above, the cable STB with VOIP 100 will support IP layer and will also support standard Transmission Control Protocol (“TCP”), User Datagram Protocol (“UDP”), Simple Network Management Protocol (“SNMP”), Internet Control Message Protocol (“ICMP”), DHCP, Address Resolution Protocol (“ARP”), Reverse Address Resolution Protocol (“RARP”). In addition, other protocols like Hypertext Transfer Protocol (“HTTP”), Trivial File Transfer Protocol (“TFTP”), and File Transfer Protocol (“FTP”).

The DSP 134 functions along with Dual Tone Multi-Frequency (DTMF) detection and generation functions. In addition, the ADC codec 136 includes circuitry to provide support for G.711, ITU standard G.726, and G.729 ITU standards for audio companding.

There has been described an advance cable STB over VOIP. It should be understood that the particular embodiments described within this specification are for purposes of example and should not be construed to limit the invention. Further, it is evident that those skilled in the art may now make numerous uses and modifications of the specific embodiment described, without departing from the inventive concepts.

What is claimed:

1. A cable set-top box with voice over internet protocol comprising:
a housing;
a coaxial cable input for accepting a coaxial cable containing a video content signal and a data content signal from a provider, said data content signal for providing said voice over internet protocol to a telecommunication's device;
a demultiplexer for splitting said video content signal and said data content signal;
a video output for accepting a video line for transmitting said video content signal to a video device; and
a data output for accepting an audio line for transmitting said data content signal to a telecommunications device.

2. The cable set-top box with voice over internet protocol of claim 1 further comprising a tuner for selecting a particular video content signal.

3. The cable set-top box with voice over internet protocol of claim 1 further comprising at least one of a digital signal processor and analog to digital converter codec for processing said data content signal.

4. The cable set-top box with voice over internet protocol of claim 1 wherein said video content signal and said data content signal conform to digital over cable interface specification standards (“DOCSIS”).

5. The cable set-top box with voice over internet protocol of claim 1 wherein said demultiplexer further differentiates said data content signal and said video content signal based on the header information contained in one of the layer 3 and layer 4 of the OSI model data packets containing said data content signal and said video content signal.

6. The cable set-top box with voice over internet protocol of claim 1 wherein said demultiplexer further includes time division multiple access protocols.

7. The cable set-top box with voice over internet protocol of claim 1 further comprising an electronic unit operating under dynamic host configuration protocol for processing said data content signal.

8. The cable set-top box with voice over internet protocol of claim 1 further comprising at least one of a Quadrature Amplitude Modulation encoder and decoder.

9. The cable set-top box with voice over internet protocol of claim 1 further comprising circuitry for interconnecting said coaxial input, said demultiplexer, said video output, and said data output.

10. The cable set-top box with voice over internet protocol of claim 1 wherein said provider is a cable TV operator.

11. A cable set-top box with voice over internet protocol comprising:
a housing;
an input means for accepting a coaxial cable containing a video content signal and a data content signal from a provider, said data content signal for providing said voice over internet protocol to a telecommunication's device;
a demultiplexer means for splitting said video content signal and said data content signal;
a video output means for accepting a video line for transmitting said video content signal to a video device; and
a data output means for accepting an audio line for transmitting said data content signal to a telecommunications device.

12. The cable set-top box with voice over internet protocol of claim 11 further comprising a means for tuning a particular video content signal.

13. The cable set-top box with voice over internet protocol of claim 11 further comprising a means for processing said data content signal.

14. The cable set-top box with voice over internet protocol of claim 11 further comprising a means for converting an analog signal to a digital signal for processing said data content signal.

15. The cable set-top box with voice over internet protocol of claim 11 wherein said video content signal and said data content signal conform to digital over cable interface specification standards (“DOCSIS”).

16. The cable set-top box with voice over internet protocol of claim 11 wherein said means for demultiplexing further differentiates said data content signal and said video content signal based on the header information contained in one of the layer 3 and layer 4 of the OSI model data packets containing said data content signal and said video content signal.

17. The cable set-top box with voice over internet protocol of claim 11 wherein said means for demultiplexing further includes time division multiple access protocols.

18. The cable set-top box with voice over internet protocol of claim 11 further comprising a means for processing said data content signal under an electronic unit operating under dynamic host configuration protocols.

19. The cable set-top box with voice over internet protocol of claim 11 further comprising at least one of means for encoding and means for decoding using Quadrature Amplitude Modulation.
